(19) United States
(12) Patent Application Publication
(10) Pub. No.: US 2021/0314278 A1
(43) Pub. Date: Oct. 7, 2021

(54) COMMUNICATION SYSTEM AND COMMUNICATION METHOD

(71) Applicant: Nippon Telegraph and Telephone Corporation, Tokyo (JP)

(72) Inventors: Minoru YAMAGUCHI, Tokyo (JP); Yoshinori KOIKE, Tokyo (JP); Hitoshi IRINO, Tokyo (JP); Hirotaka YOSHIOKA, Tokyo (JP)

(21) Appl. No.: 17/267,611

(22) PCT Filed: Aug. 7, 2019
(86) PCT No.: PCT/JP2019/031074

§ 371 Date: Feb. 10, 2021

(30) Foreign Application Priority Data
Aug. 13, 2018 (JP) 2018-152241

(51) Int. Cl. H04L 12/937; H04L 12/851; H04L 12/933; H04L 12/46

(52) U.S. Cl. CPC H04L 49/254; H04L 12/4641; H04L 49/10; H04L 47/24

(57) ABSTRACT

[Problem] Efficiently utilizing physical resources in a communication system that builds a virtual network based on various requirements.

[Solution] A communication system (10) includes a Spine switch group (12) consisting of a plurality of Spine switches (102), a Leaf switch group (14) consisting of a plurality of Leaf switches (104), a plurality of servers (106) connected to any one of the plurality of Leaf switches (104), and a controller (110) configured to build a virtual network on the physical resources. At least one of the Spine switch group (12) and the Leaf switch group (14) is constituted by a mix of switch devices having different performance. The controller (110) selects physical resources to be used for building the virtual network based on the desired performance of the virtual network.

### TECHNICAL FIELD

The present invention relates to a communication system and a communication method, more particularly to a communication system with a multi-grade fabric configuration and a communication method for a multi-grade service.

### BACKGROUND ART

In known technology, function separation of network devices and packet-transport integration have been promoted to combine multi-vendor apparatuses and configure a network. For example, Non Patent Literature (NPL) 1 below describes a slice network proposed as a method for building a flexible virtual network. In NPL 2 below, segment routing is defined based on tag information.

### CITATION LIST

### Non Patent Literature

NPL 1: 3GPP TR23.799 V14.0.0: “Study on Architecture for Next Generation System,” 2016.
NPL 2: “RFC8402: Segment Routing Architecture” [online], [Searched on Jul. 30, 2018], Internet <URL: https://www.rfc-editor.org/rfc/rfc8402.txt>

### SUMMARY OF THE INVENTION

### Technical Problem

For recent communication systems, virtual networks (vNW) need to be built according to various requirements. For the physical resources that constitute the communication system, devices having uniform performance are generally used. When the physical resources are configured of devices having uniform performance, there is a problem in that physical resources are deployed according to the virtual network having the highest performance requirements. As a result, physical resources may be utilized inefficiently.

FIG. 12 is a diagram illustrating the configuration of a communication system according to known technology.

The communication system 30 includes a plurality of Spine switches (designated as “Spin SW” in the drawing) 302, a plurality of Leaf switches (designated as “Leaf SW” in the drawing) 304, and a server 306 in which a virtual machine (VM) is activated to execute an application.

FIG. 13 illustrates an example of a virtual network (network slice) built on a communication system. This virtual network is constituted of a mix of virtual networks having different requirements, that is, a temporary slice S1, a video distribution slice S2, a low-latency slice S3, a supervisory control slice S4, a high-secure slice S5, and a best-effort slice S6.

The Spine switches 302 and the Leaf switches 304 illustrated in FIG. 12 are each devices having uniform performance (e.g., a black box switches). In other words, in the communication system 30, a cluster is formed of switches having uniform performance, and this performance is satisfactory for building each slice illustrated in FIG. 13. On the other hand, the performance required for each slice to be executed differs, and not all physical resources always operate with the highest performance. Thus, there is room to improve the efficiency of physical resources.

In light of the foregoing, an object of the present invention is to efficiently utilize physical resources in a communication system that builds virtual networks having various requirements.

### Means for Solving the Problem

To achieve the object described above, a first aspect of the present invention provides a communication system includes: physical resources including a Spine switch group consisting of a plurality of Spine switches, a Leaf switch group consisting of a plurality of Leaf switches, and a plurality of servers connected to any one of the Leaf switches, and a controller configured to build a virtual network on the physical resources, in which at least one of the plurality of Spine switch group and the plurality of Leaf switch group is constituted by a mix of switch devices having different performance, and the controller selects a physical resource of the physical resources used to build the virtual network based on desired performance of the virtual network.

A fourth aspect of the present invention provides a communication method for building a virtual network on physical resources including a Spine switch group consisting of a plurality of Spine switches, a Leaf switch group consisting of a plurality of Leaf switches, and a plurality of servers connected to any one of the plurality of Leaf switches, the communication method including: selecting a physical resource of the physical resources to be used for building the virtual network based on desired performance of the virtual network, in which at least one of the Spine switch group and the Leaf switch group is constituted by a mix of switch devices having different performance.

With this configuration, physical resources to be used can be selected as appropriate according to the desired performance of the virtual network, and systems can be constructed more efficiently (at low cost) than when uniformly disposing all physical resources based on the virtual network with the highest performance requirements.

In addition, in the communication system according to a second aspect of the present invention the controller obtains performance information of each of the plurality of Spine switches and each of the plurality of Leaf switches, sequentially monitors an operational status of each of the plurality of Spine switches and each of the plurality of Leaf switches, and selects a Spine switch of the plurality of Spine switches, a Leaf switch of the plurality of Leaf switches, and a server of the plurality of servers to be used to build the virtual network.

The communication method according to fifth aspect of the present invention further includes obtaining performance information of each of the plurality of Spine switches and each of the plurality of Leaf switches, and monitoring an operational status of each of the plurality of Spine switches and each of the plurality of Leaf switches, in which, in the resource selection step, a Spine switch of the plurality of Spine switches, a Leaf switch of the plurality of Leaf switches, and a server of the plurality of servers to be used for building the virtual network are selected based on the information obtained in the performance information obtainment step.

With this configuration, appropriate physical resources can be selected according to the desired performance of the virtual network.

Furthermore, in the communication system according to a third aspect of the present invention, the Spine switch group is constituted by optical path switches, and the Leaf switch group is constituted by a mix of switch devices having different performance.

In the communication method according to the sixth aspect of the present invention, the Spine switch group is constituted by optical path switches, and the Leaf switch group is constituted by a mix of switch devices having different performance.

With this configuration, Leaf-to-Leaf traffic can be isolated and bandwidth can be secured to improve communication quality.

### Effects of the Invention

According to the present invention, physical resources can be efficiently utilized in a communication system that builds virtual networks having various requirements.

### BRIEF DESCRIPTION OF DRAWINGS

FIG. 1 is a diagram illustrating a configuration example of a communication system according to a first embodiment.

FIG. 2 is a table showing an example of performance information of each switch device and the results of monitoring the operational status of each switch device.

FIG. 3 is a table showing desired performance of virtual networks.

FIG. 4 is an explanatory diagram schematically illustrating an example of communication paths for each virtual network.

FIG. 5 is an explanatory diagram schematically illustrating an example of communication paths according to known technology.

FIG. 6 is a flowchart illustrating processing of the communication system.

FIG. 7 is a diagram illustrating a configuration example of a communication system according to a second embodiment.

FIG. 8 is a diagram illustrating an example of a connection relationship between Leaf switches in a layer 2.

FIG. 9 is an explanatory diagram of a band expansion method without increasing the number of Spine switches.

FIG. 10 is an explanatory diagram of a redundancy method for Spine switches without increasing the number of Leaf switch ports.

FIG. 11 is a diagram illustrating a Leaf-Spine configuration according to known technology.

FIG. 12 is an explanatory diagram illustrating a physical resource configuration of a communication system according to known technology.

FIG. 13 is a diagram illustrating an example of a virtual network built on a communication system.

FIG. 14 is a diagram illustrating a Leaf-Spine configuration according to known technology.

### DESCRIPTION OF EMBODIMENTS

### First Embodiment

Hereinafter, preferred embodiments of a communication system and a communication method according to the present invention will be described in detail with reference to the accompanying drawings.

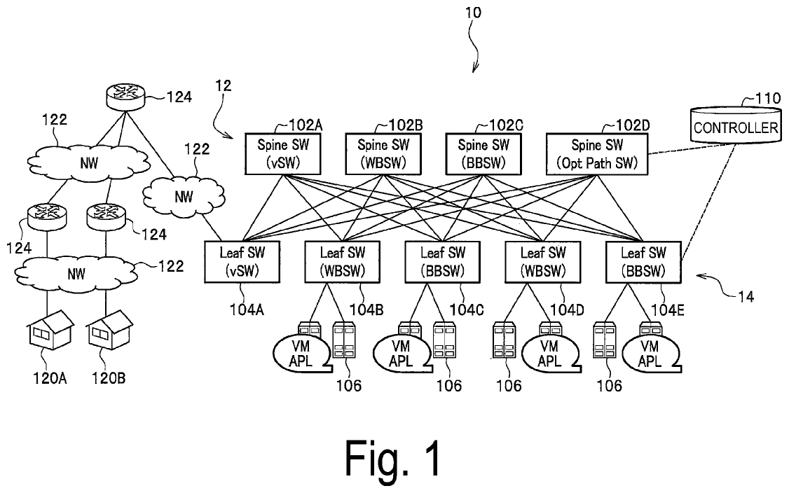

FIG. 1 is a diagram illustrating a configuration example of a communication system according to a first embodiment.

A communication system 10 according to the first embodiment includes a physical resource including a Spine switch group 12 consisting of a plurality of Spine switches (designated as “Spin SW” in the FIGS. 102 (102A to 102D), a Leaf switch group 14 consisting of a plurality of Leaf switches (designated as “Leaf SW” in the FIGS. 104 (104A to 104E), and a plurality of servers 106 connected to any one of the Leaf switches 104, and a controller 110 configured to build virtual networks on the physical resource.

The plurality of Spine switches 102 and the plurality of Leaf switches 104 are connected in full mesh topology.

To facilitate visibility in the drawings, connection lines are partially omitted. However, the controller 110 is connected to all switches (Spine switches 102 and Leaf switches 104) in the communication system 10.

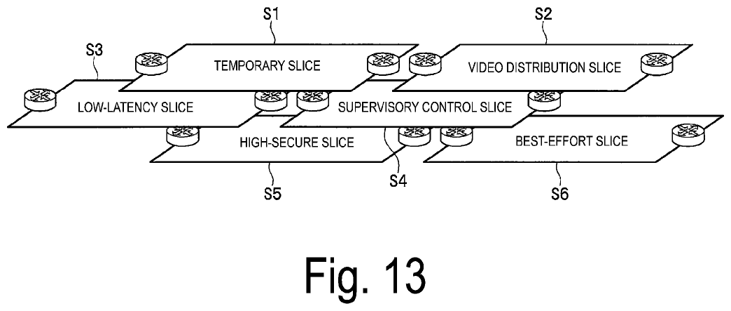

Various types of virtual networks (see FIG. 13) are built on the physical resources that configure the communication system 10 based on requests from users (user terminals) 120 (120A, 120B). The users 120 are connected to any Leaf switch 104 via a plurality of networks 122 and a router 124.

Here, at least one of the Spine switch group 12 and the Leaf switch group 14 is constituted of a mix of switch devices having different performance. In other words, the communication system 10 has a multi-grade fabric configuration.

In the first embodiment, both the Spine switch group 12 and the Leaf switch group 14 are constituted of a mix of switch devices having different performance.

In the example of FIG. 1, the Spine switch 102A is a virtual switch (vSW), the Spine switch 102B is a white box switch (WBSW), the Spine switch 102C is a black box switch (BBSW), and the Spine switch 102D is an optical path switch (Opt Path SW).

In addition, the Leaf switch 104A is a virtual switch (vSW), the Leaf switch 104B and the Leaf switch 104D are white box switches (WBSW), and the Leaf switches 104C and 104E are black box switches (BBSW).

A network configured by devices having different performance as described above may form a path between switches having varying performance depending on the performance of the switches passing through the path.

Thus, the controller 110 selects physical resources to be used for building a virtual network based on the desired performance of the virtual network.

More specifically, the controller 110 obtains performance information of each Spine switch 102 and each Leaf switch 104. In addition, the controller 110 sequentially monitors the operational statuses of the Spine switches 102 and the Leaf switches 104 (including the link performance between the Spine switches 102 and the Leaf switches 104) and selects the Spine switch 102, the Leaf switch 104, and the server 106 to be used for building the virtual network.

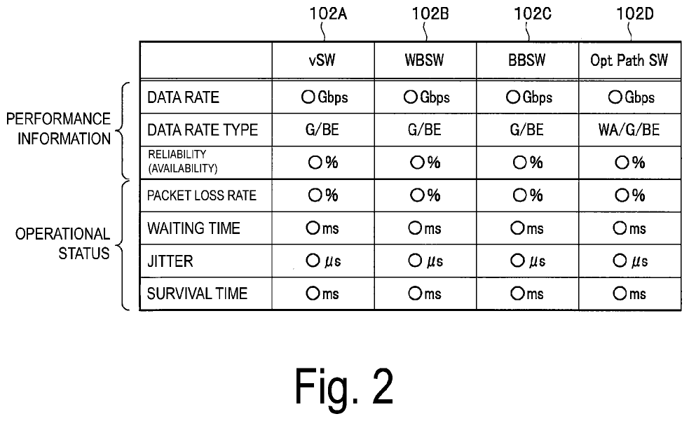

FIG. 2 is a table showing performance information of each switch device and the results of monitoring the operational status of each switch device.

FIG. 2 shows performance information and operational status of the Spine switch 102A, which is a virtual switch (vSW), the Spine switch 102B, which is a white box switch (WBSW), the Spine switch 102C, which is a black box switch (BBSW), and the Spine switch 102D, which is an optical path switch (Opt Path SW) in the stated order from the left.

Note that all of the locations corresponding to the numerical values in FIG. 2 are designated as circles, and each of the numbers contains a different numerical value. In addition, among the information indicated as data rate type, G represents Guarantee (Bandwidth Guarantee), BE represents Best Effort, and WA represents Wavelength Assignment.

The performance information of each switch device is static information determined based on the intrinsic performance of each device. The operational status of each switch device is variable information obtained by monitoring the performance of each switch device. Examples of the performance information of each switch device include data rate, data rate type, and reliability (availability).

Examples of the operational status of each switch device include packet loss rate, wait time, jitter, and survival time.

In addition, the controller 110 monitors the performance of the link connecting each Spine switch 102 and each Leaf switch 104.

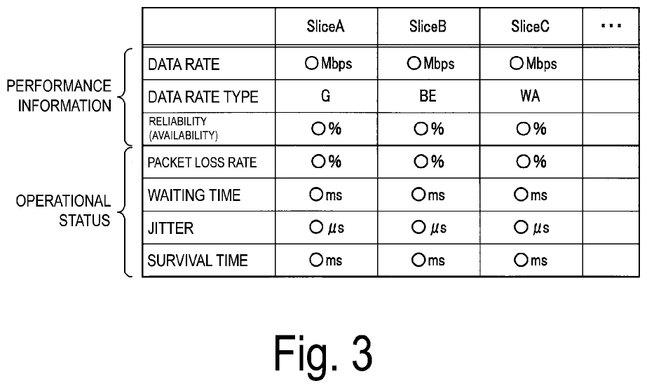

FIG. 3 is a table showing an example of desired performance of virtual networks. FIG. 3 shows the desired performance of a slice (designated as “Slice” in the figure) A, a slice B, and a slice C in the stated order from the left. Each item is the same as the performance information and the operational status of the switches illustrated in FIG. 2.

Note that the items of performance information and operational status illustrated in FIGS. 2 and 3 are merely examples, and other items not illustrated in FIGS. 2 and 3 may be set as the performance information or the operational status.

The controller 110 selects physical resources that match the request for the virtual network, and determines a communication path and the server 106 to execute the application. That is, the controller 110 selects an input Leaf switch port, a relay Spine switch, an output Leaf switch port, and an application execution server depending on the desired performance of the virtual network.

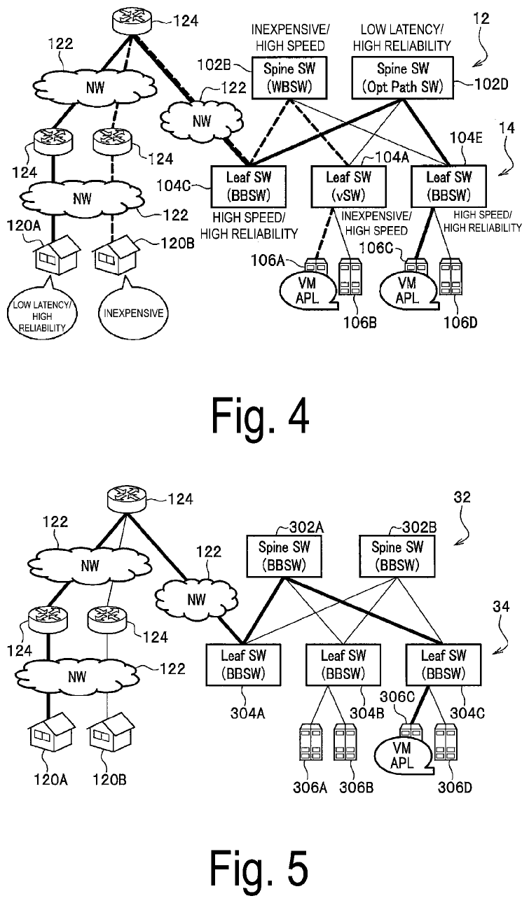

FIG. 4 is an explanatory diagram schematically illustrating an example of communication paths for each virtual network.

In FIG. 4, the Spine switch 102B, which is a white box switch (WBSW), and the Spine switch 102D, which is an optical path switch (Opt Path SW), are illustrated as the Spine switch group 12. Further, the Leaf switch 104A, which is a virtual switch (vSW), and the Leaf switches 104C and 104E, which are black box switches (BBSW), are illustrated as the Leaf switch group 14. Servers 106A and 106B are connected to the Leaf switch 104A, and servers 106C and 106D are connected to the Leaf switch 104E. Note that the controller 110 is omitted from FIG. 4.

The Spine switch 102B, which is a white box switch (WBSW), is inexpensive and has high speed. The Spine switch 102D, which is an optical path switch (Opt Path SW), has low latency and high reliability. The Leaf switch 104A, which is a virtual switch (vSW), is inexpensive and has high speed. The Leaf switches 104C and 104E, which are black box switches (BBSW), have high speed and high reliability.

Note that the characteristics of these switches are the result of abstractly paraphrasing the performance information and operational status (numerical information) of each switch as illustrated in FIG. 2.

Here, the user (user terminal) 120A has the need to utilize a virtual network with low latency and high reliability. The user (user terminal) 120B has the need to utilize a virtual network at low cost above all else. Virtual networks with types compatible with each of these needs are selected, and physical resources (communication paths) matching the desired performance of each virtual network (see FIG. 3) are selected.

For example, for the user 120A, as indicated by the thick lines in FIG. 4, the Leaf switch 104C, the Spine switch 102D (low latency and high reliability), the Leaf switch 104E (high speed and high reliability), and the server 106C are selected as the physical resources that provide the virtual network.

For the user 120B, as indicated by the dashed lines in FIG. 4, the Leaf switch 104C, the Spine switch 102B (inexpensive and high-speed), the Leaf switch 104A (inexpensive and high-speed), and the server 106A are selected as the physical resources that provide the virtual network.

FIG. 5 is an explanatory diagram schematically illustrating an example of a communication path according to known technology.

As illustrated in FIG. 5, in known technology, a Spine switch group 32 (Spine switches 302A and 302B) and a Leaf switch group 34 (Leaf switches 304A to 304C) are switches that form a cluster and have uniform performance (all black box switches (BBSW) in the example of the figure). Further, the location of the application (any one of the servers 306A to 306D) is defined, and the communication path is defined regardless of the desired performance of the virtual network.

For example, as indicated by the bold lines in FIG. 5, if the user 120A is to use a virtual network in which the application is located in the server 306C, then, the Leaf switch 304A, the Spine switch 302A, the Leaf switch 304C and the server 306C form the communication path.

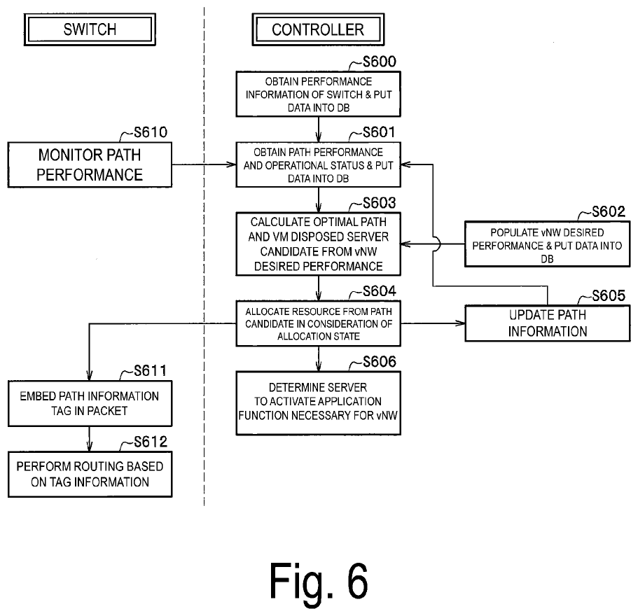

FIG. 6 is a flowchart illustrating processing of the communication system.

The controller 110 obtains the performance information (static information) of each switch device in the communication system 10 and puts the data into a database (DB) (Step S600: Performance information obtainment step).

Each switch device sequentially monitors the performance of a path connecting that switch device itself to another switch device (Step S610).

The controller 110 obtains path performance information from each switch device, monitors (obtains) the operational status of each switch device, and puts the data into a database with these pieces of dynamic information (Step S601: Performance information obtainment step).

The controller 110 is populated with the desired performance of each virtual network (vNW) and puts the data into a database of this information (Step S602).

The controller 110 compares the desired performance of each virtual network with the contents of the consequential databases of Steps S600 and S601, and then calculates candidates for the optimal path (the switch devices through which signals passes) and the server 106 in which the virtual machine (VM) is disposed (Step S603).

Then, in consideration of the current allocation state, the physical resource that is actually set as the path from the path candidates is selected, and a path is allocated (Step S604: Resource selection step).

The controller 110 updates the path information based on the result of allocation in Step S604 (Step S605). Then, the server 106 that activates the application function necessary for building the virtual network is determined (Step S606: Resource selection step).

Each switch device also embeds a tag of the path information determined in Step S604 in a packet (Step S611) and performs routing based on the tag information (Step S612).

As described above, with the communication system 10 according to the first embodiment, the physical resources to be used can be selected as appropriate based on the desired performance of the virtual network, and a system can be constructed more efficiently (at low cost) than when uniformly disposing all of the physical resources according to the virtual network with the highest performance requirements.

### Second Embodiment

In the first embodiment, a case is described in which both the Spine switch group and the Leaf switch group are constituted of a mix of switch devices having different performance. The second embodiment deals with a case where the Spine switch group is constituted by only optical path switches and the Leaf switch group is constituted by a mix of switch devices having different performance.

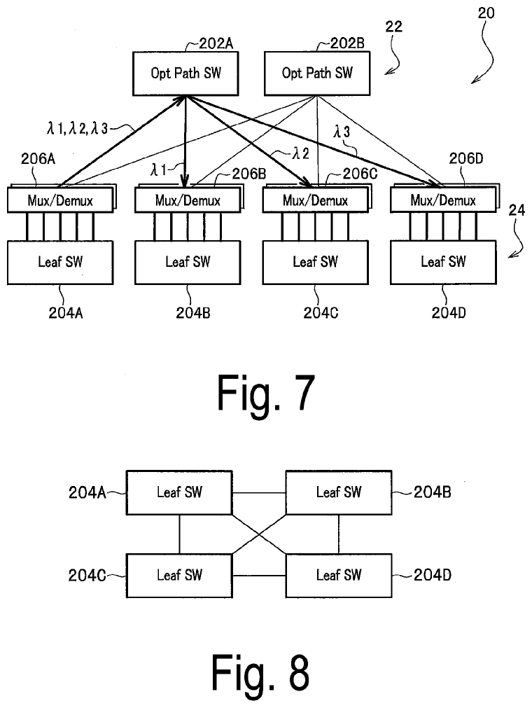

FIG. 7 is a diagram illustrating a configuration example of a communication system according to the second embodiment.

In a communication system 20 according to the second embodiment illustrated in FIG. 7, configurations other than that of a Spine switch group 22 and a Leaf switch group 24 are the same as that of FIG. 1, and thus illustration thereof is omitted. In other words, FIG. 7 illustrates a Leaf-Spine configuration according to the second embodiment.

In the communication system 20, the Spine switches 202 (202A and 202B, designated as “Opt Path SW” in the drawing) are both optical path switches (Opt Path SW). With the optical path switch, wavelength separation is performed on wavelength-multiplexed input signals output from each Spine switch 202 and wavelength routing is performed in accordance with a previously constructed path to multiplex the input signals and transmit data to the output side of each Spine switch. A switch other than an optical path switch is a layer 2 (L2) or a layer 3 (L3) switch, whereas an optical path switch is a layer 0 (L0) or a layer L1 (L1) switch, and is a switch underlying than other switches. The optical path switch switches the optical path itself, through which a layer 2 (L2) signal or a layer 3 (L3) signal transmitted from another other switch passes. An optical path switch cannot recognize itself from other switches.

The Leaf switches 204 (204A to 204D) are any type of switch device. The Leaf switches 204 are connected to wavelength multi/demultiplexer modules (Mux/Demux) 206 (206A to 206D). The wavelength multi/demultiplexer module 206 outputs a plurality of single wavelength signals having different wavelengths input from the Leaf switch 204 as one wavelength multiplexed (WDM) signal to the Spine switch 202 (Mux). The wavelength multi/demultiplexer module 206 then splits the one WDM signal input from the Spine switch 202 into a plurality of single wavelength signals and outputs these signals to the Leaf switch 204 (Demux).

For example, when signals having wavelengths of λ1, λ2, λ3 are input from the Leaf switch 204A to the wavelength multi/demultiplexer module 206A, the wavelength multi/demultiplexer module 206A outputs the signals having the wavelengths λ1, λ2, λ3 to the Spine switch 202A as one WDM signal. The Spine switch 202A uses wavelength routing to output the signal having the wavelength λ1 to a wavelength multi/demultiplexer module 206B (Leaf switch 204B), the signal having the wavelength λ2 to a wavelength multi/demultiplexer module 206C (Leaf switch 204C), and the signal having the wavelength λ3 to a wavelength multi/demultiplexer module 206D (Leaf switch 204D).

By using an optical path switch as the Spine switch 202, separating (isolating) the wavelength for each requirement when providing networks for diverse traffic with different requirements can generate independent bands between wavelengths. This not only provides economic paths that are statistically multiplexed as in known technology, but also generates completely independent high quality signals that ensure bands and not affect other traffic.

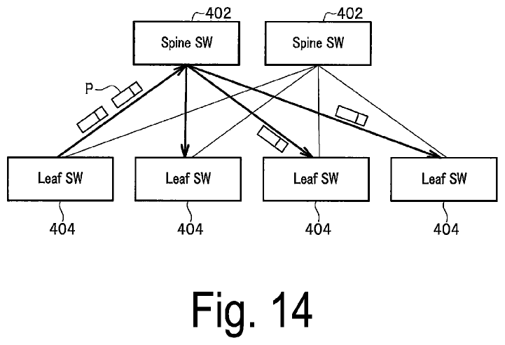

FIG. 14 is a diagram illustrating a Leaf-Spine configuration according to known technology. The Leaf-Spine configuration according to known technology electrically terminates a packet P transmitted from the Leaf switch 404 at the Spine switch 402 to electrically perform packet switching.

In other words, in a known Clos topology, Leafs are not directly connected to each other for horizontal traffic exchange between Leafs, and traffic flows through Spines in an upper hierarchy to other Leafs. This leads to problems such as poor efficiency, reduced performance, and band compression.

In contrast, with the configuration according to the present invention illustrated in FIG. 7, optical path switches are used as the Spines to form a fabric configuration in which optical path switching is performed without electrical termination to terminate directly at the destination Leaf. In other words, as illustrated in FIG. 8, the hierarchical structure is eliminated on the layer 2 (L2) and all the Leaf switches 204 are directly connected horizontally in a full mesh topology. This facilitates high quality Leaf switch-to-switch connections.

An example of an optical path switch described above is an Arrayed Waveguide Grating (AWG) router. The AWG router builds a full mesh network using cyclic AWG. More specifically, a full-mesh network can be built with star-shaped optical fibers, which can greatly reduce the number of fiber optics. In addition, since there is no need to mutually convert light and electricity, no power supply is necessary which makes the network highly reliable.

Further, bandwidth can be expanded without adding Spine switches 202 by using the transmission characteristics of a wavelength router such as the AWG router to insert multiple signals into wavelength paths on the same path. Specifically, the following methods are conceivable.

Method 1

Multiple signals are routed to the same path by passing multiple signals through the same transmission band.

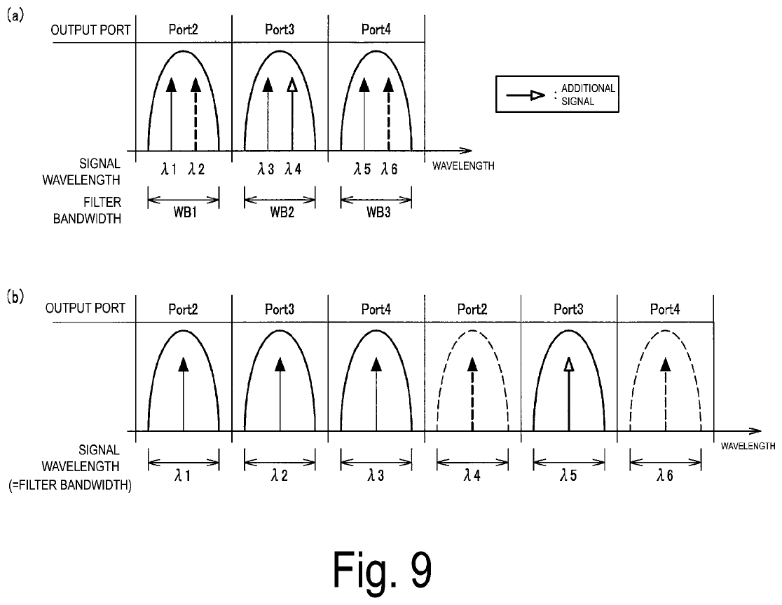

For example, in FIG. 9(a), one input port (Port) of the Spine switch 202 is configured such that an input signal inside the filter bandwidth WB1 is output to an output port (Port) 2, and thus a signal having the wavelength λ1 is output from the output port (Port) 2. Similarly, another input port (Port) is configured such that an input signal inside the filter bandwidth WB2 is output to an output port (Port) 3, and thus a signal having the wavelength λ3 is output from the output port (Port) 3. Further, another input port (Port) is configured such that an input signal inside the filter bandwidth WB3 is output to an output port (Port) 4, and thus a signal having the wavelength λ5 is output from the output port (Port) 4.

If bandwidth expansion is required in such a state (e.g., if an additional signal S is output from the Leaf switch 204), a signal having the wavelength λ4 included in the filter bandwidth WB2 (additional signal) is configured to be output from the output port 3. Similarly, a signal having the wavelength λ2 included in the filter bandwidth WB1 (indicated by the dotted line) is configured to be output from the output port 2. Further, the signal having the wavelength λ6 included in the filter bandwidth WB3 (indicated by the dotted line) is configured to be output from the output port 4. That is, the Method 1 is a method of performing bandwidth expansion by causing a plurality of signals to pass through one wavelength band filter.

Method 2

Individual signals are passed through a plurality of bands that perform the same routing to route multiple signals to the same path.

For example, in FIG. 9(b), one input port (Port) of the Spine switch 202 is configured such that an input signal inside the filter bandwidth λ1 is output to the output port (Port) 2, and thus a signal having the wavelength λ1 is output from the output port (Port) 2. Similarly, another input port (Port) is configured such that an input signal inside the filter bandwidth λ2 is output to the output port (Port) 3, and thus a signal having the wavelength λ2 is output from the output port (Port) 3. Further, another input port (Port) is configured such that an input signal inside the filter bandwidth λ3 is output to the output port (Port) 4, and thus a signal having the wavelength λ3 is output from the output port (Port) 4.

If bandwidth expansion is required in such a state, for example, a filter (filter bandwidth=λ5) is set to the output port 3 such that a signal having the wavelength λ5 is output, causing the signal having a wavelength λ5 (additional signal) to be output in addition to a signal having the wavelength λ2. Similarly, a filter (filter bandwidth=λ4) is set to the output port 2 such that a signal having the wavelength λ4 is output, causing the signal having the wavelength λ4 (indicated by the dotted line) to be output in addition to a signal having the wavelength λ1. In addition, in the output port 4, a filter (filter bandwidth=λ6) is set to the output port 4 such that a signal having the wavelength λ6 is output, causing a signal having a wavelength λ6 (indicated by a dotted line) to be output in addition to a signal having the wavelength λ3. That is, Method 2 is a method of performing band expansion by setting a plurality of wavelength band filters for one output port.

Method 3

Method 1 and Method 2 can also be used in combination.

Further, redundancy of the Spine switch 202 can be achieved without adding a port on the Leaf switch 204 side, for example.

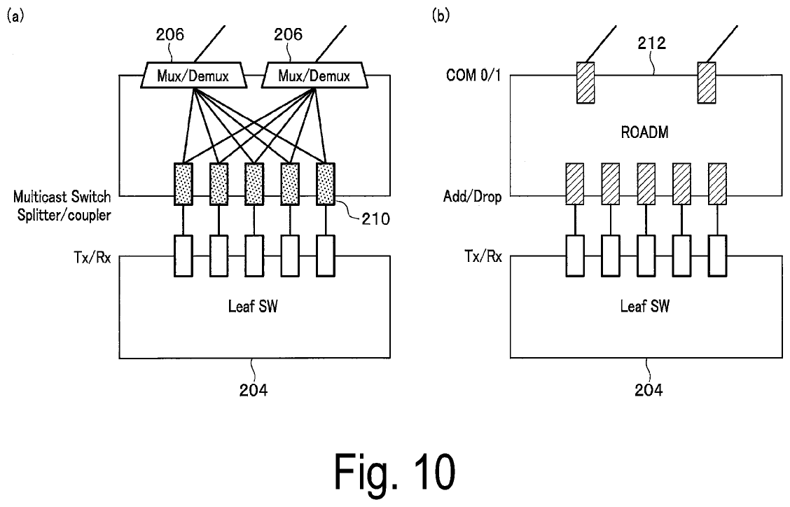

For example, as illustrated in FIG. 10(a), a multicast switch 210 is disposed prior to the wavelength multi/demultiplexer module (Mux/Demux) 206 on the Leaf switch 204 side. Alternatively, as illustrated in FIG. 10(b), the wavelength multi/demultiplexer module (Mux/Demux) 206 is set as a reconfigurable optical add/drop multiplexer (ROADM) 212 to enable redundancy without adding a transmission port for the Leaf switch 204.

In terms of a cluster-to-cluster connection configuration, the Spine router does not have a switch function, which results in a configuration that connects Borders and Leafs (B-Leaf) to each other.

While configuring a Spine-to-Spine connection model is not possible, a B-Leaf-to-B-Leaf connection model is superior to a Spine-to-Spine connection model in terms of scalability, redundancy-cluster operation efficiency, and transition from single clusters to multiple clusters. Further, B-Leaf-to-B-Leaf connection is common in view of city trends.

The performance of the communication system according to the second embodiment (designated as the present invention) and the performance of known configurations are discussed in comparison.

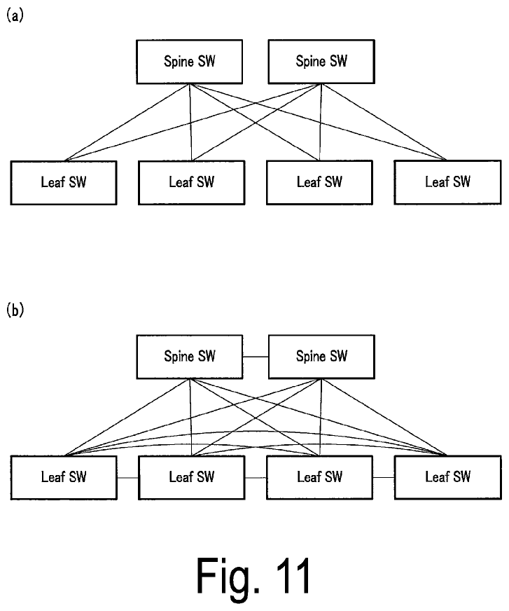

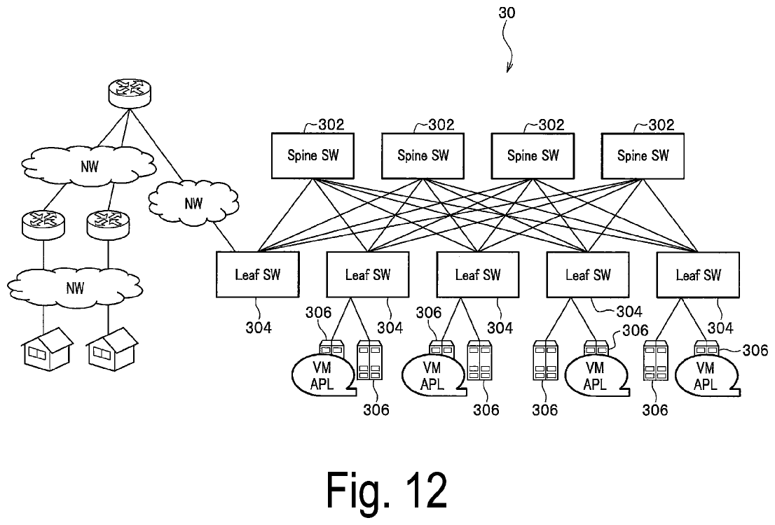

The known configurations to be compared are the Clos network illustrated in FIG. 11(a) and the Fullmesh network illustrated in FIG. 11(b).

Traffic Quality Between Leafs

In a Clos network, bandwidth between Leafs is shared, but the network is strong against fluidity and has efficient accommodation through statistical multiplexing. A Fullmesh network has two types, that is, a type where Leafs are directly connected to each other and a type where statistical multiplexing is shared via the Spines. As a result, accommodation can be made efficient by understanding and designing cross traffic in network. In contrast, in the present invention, Leaf-to-Leaf traffic can be isolated and bandwidth can be secured such that this traffic is not affected by traffic on other paths and communication quality is further improved. Low latency transfer is also possible. That is, in terms of Leaf-to-Leaf traffic quality, the present invention is advantageous over known configurations of Clos networks and Fullmesh networks.

Failure Resistance

A Clos network is capable of switching only fault sites, and only traffic accommodated by the fault sites is affected. The same applies to a Fullmesh network, where only fault sites can be switched and only traffic accommodated by the fault sites is affected. In contrast, while in the present invention only fault sites can be switched and only traffic accommodated by the fault sites is affected similarly to the above network types, in terms of failure resistance, the present invention achieves higher Spine reliability and higher reliability of clusters than Clos networks and Fullmesh networks, and is therefore advantageous over known configurations.

Operability

In a Clos network, it is difficult to secure routes when balancing load. In a Fullmesh network, it is difficult to secure routes when balancing load, but direct connection between Leafs can be identified. In contrast, in the present invention, Leafs appear to be directly connected to each other in a full mesh topology in layers L2 and above, and this configuration is easy to control because P2P connection is established. In other words, the present invention is advantageous over known configurations of Clos networks and Fullmesh networks.

Considering an effective use case of the present invention, the present invention is effective in cases where low latency transfer is required, or when Leaf-to-Leaf traffic is often fixed. For example, the present invention is considered effective in a small data center (DC) such as a data center interconnect (DCI) or in a metropolitan area such as a capital city because scalability in terms of number of ports is low and costs are low.

### REFERENCE SIGNS LIST

10, 20 Communication system
12, 22 Spine switch group
14, 24 Leaf switch group
102 (102A to 102D), 202 (202A, 202B) Spine switch
104 (104A to 104E), 204 (204A to 204D) Leaf switch
106 (106A to 106D) Server
110 Controller
120 (120A, 120B) User (user terminal)
124 Router
206 (206A to 206D) Wavelength multi/demultiplexer module

1. A communication system comprising:
physical resources including:
a Spine switch group consisting of a plurality of Spine switches;
a Leaf switch group consisting of a plurality of Leaf switches; and
a plurality of servers connected to any one of the plurality of Leaf switches; and
a controller configured to build a virtual network on the physical resources,
wherein
at least one of the Spine switch group and the Leaf switch group is constituted by a mix of switch devices having different performance, and
the controller is configured to select a physical resource of the physical resources used to build the virtual network based on desired performance of the virtual network.

2. The communication system according to claim 1, wherein the controller is configured to obtain performance information of each of the plurality of Spine switches and each of the plurality of Leaf switches, sequentially monitor an operational status of each of the plurality of Spine switches and each of the plurality of Leaf switches, and select a Spine switch of the plurality of Spine switches, a Leaf switch of the plurality of Leaf switches, and a server of the plurality of servers to be used to build the virtual network.

3. The communication system according to claim 1, wherein the Spine switch group is constituted by optical path switches, and the Leaf switch group is constituted by a mix of switch devices having different performance.

4. A communication method for building a virtual network on physical resources including a Spine switch group consisting of a plurality of Spine switches, a Leaf switch group consisting of a plurality of Leaf switches, and a plurality of servers connected to any one of the plurality of Leaf switches, the communication method comprising:
selecting a physical resource of the physical resources to be used for building the virtual network based on desired performance of the virtual network,
wherein at least one of the Spine switch group and the Leaf switch group is constituted by a mix of switch devices having different performance.

5. The communication method according to claim 4, further comprising:
obtaining performance information of each of the plurality of Spine switches and each of the plurality of Leaf switches, and monitoring an operational status of each of the plurality of Spine switches and each of the plurality of Leaf switches,
wherein, in the resource selection step, a Spine switch of the plurality of Spine switches, a Leaf switch of the plurality of Leaf switches, and a server of the plurality of servers to be used for building the virtual network are selected based on the performance information obtained in the performance information obtainment step.

6. The communication method according to claim 4, wherein the Spine switch group is constituted by optical path switches, and the Leaf switch group is constituted by a mix of switch devices having different performance.
